(19) United States
(12) Patent Application Publication
(10) Pub. No.: US 2025/0391181 A1
(43) Pub. Date: Dec. 25, 2025

(54) SYSTEMS AND METHODS FOR PREDICTING BOUNDARY LINES ON A ROAD BY COMPARING DATA AND RESOLVING CONFLICTS

(71) Applicant: Toyota Jidosha Kabushiki Kaisha, Toyota-shi Aichi-ken (JP)

(72) Inventor: Alexander Christoph Schaefer, Fremont, CA (US)

(21) Appl. No.: 18/752,972

(22) Filed: Jun. 25, 2024

(51) Int. Cl. G06V 20/56; G06V 10/74

(52) U.S. Cl. CPC G06V 20/588; G06V 10/761; G06V 2201/08

(57) ABSTRACT

Systems, methods, and other embodiments described herein relate to comparing detected line pairs on a road and detecting lane conflicts for identifying boundary lines. In one embodiment, a method includes comparing a similarity metric for different line pairs derived from detected keypoints. The method also includes detecting lane conflicts for vehicles identified with the line pairs using the similarity metric. The method also includes resolving the lane conflicts by comparing parameters of the line pairs that overlap. The method also includes generating a map with boundary lines adjusted for the lane conflicts.

### TECHNICAL FIELD

The subject matter described herein relates, in general, to predicting boundary lines on a road, and, more particularly, to comparing vehicle relationships from detected lines on the road and resolving conflicts for executing vehicle tasks.

### BACKGROUND

Vehicles acquire sensor data from on-board sensors to perceive a surrounding environment and execute various tasks, such as path planning for automated driving. For example, a vehicle equipped with a camera sensor acquires images about the surrounding environment, while logic associated detects object presence and other features of the surrounding environment. In further examples, sensors such as radar acquire information about the surrounding environment from which a system derives awareness for the vehicle tasks. This sensor data can improve perceptions of the surrounding environment for diverse driving scenarios so that systems such as automated driving systems (ADS) can accurately and safely control a vehicle accordingly.

Moreover, in one embodiment, vehicle systems acquire sensor data to estimate a road profile (e.g., number of lanes, curvature, etc.). For instance, a vehicle system processes camera data to locate road lines for navigation. The vehicle system can update the road profile with the located lines and update high-definition (HD) maps that support other vehicle tasks. For example, automatic cruise control by an ADS utilizes the updated HD map to safely navigate a road curve. However, generating maps from detected lines can have errors for complex road segments (e.g., overpasses, intersections, etc.). Such road segments can demand manual inputs for selecting the lines, thereby increasing costs and delays. Accordingly, systems detecting a road profile for managing map data and safety tasks face challenges involving complex scenarios, thereby reducing overall system performance and robustness.

### SUMMARY

In one embodiment, example systems and methods relate to comparing detected line pairs on a road and detecting lane conflicts for identifying boundary lines. In various implementations, systems detecting boundary lines on a road are computationally complex and inaccurate due to rough terrain, atypical road layouts, etc. Furthermore, systems on a vehicle acquiring data about a boundary line can involve conflicts for associating detected data with the boundary line. For example, a system identifying a lane boundary using data from a merging vehicle, a drifting vehicle, etc., erroneously associates perceived road points as the lane boundary and confuses lane occupancy for the vehicle. Thus, this vehicle scenario can create dangerous conditions for vehicle tasks that mistakenly rely upon the lane boundary, particularly for safety applications such as automated driving.

Therefore, in one embodiment, an estimation system detects and resolves lane conflicts about relationships between vehicles using a similarity metric and line pairs for identifying boundary lines. Here, a similarity metric may represent associative relationships between the vehicles and the line pairs on a road through factoring quantified geometries. The estimation system can derive a line pair from image data. The estimation system can also assemble a line pair by connecting detected keypoints for forming lines and relating the lines using vehicle trajectories. A keypoint can be a salient point derived from sensor data that matches features for objects within a scene (e.g., a driving environment). Furthermore, in one approach, detecting a lane conflict can include mistaking a line that form part of a line pair for a current lane as being associated with an adjacent lane. As such, the lane conflict involves an indication that the vehicles are traveling on a multi-lane road rather than a simpler roadway having lesser lanes. The estimation system can resolve the lane conflicts through comparing parameters of the line pairs that overlap (e.g., corresponding x-values, corresponding x and y values, etc.) across possible associative relationships and optimizing the parameters using the overlap. In this way, the estimation system identifies line pairs as boundary lines for the road with increased reliability using the optimized parameters, thereby improving vehicle tasks using the boundary lines.

In one embodiment, an estimation system that compares detected line pairs on a road and detects lane conflicts for identifying boundary lines is disclosed. The estimation system includes a memory storing instructions that, when executed by a processor, cause the processor to compare a similarity metric for different line pairs derived from detected keypoints. The instructions also include instructions to detect lane conflicts between vehicles identified with the line pairs using the similarity metric. The instructions also include instructions to resolve the lane conflicts by comparing parameters of the line pairs that overlap. The instructions also include instructions to generate a map with boundary lines adjusted for the lane conflicts.

In one embodiment, a non-transitory computer-readable medium for comparing detected line pairs on a road and detecting lane conflicts for identifying boundary lines and including instructions that when executed by a processor cause the processor to perform one or more functions is disclosed. The instructions include instructions to compare a similarity metric for different line pairs derived from detected keypoints. The instructions also include instructions to detect lane conflicts between vehicles identified with the line pairs using the similarity metric. The instructions also include instructions to resolve the lane conflicts by comparing parameters of the line pairs that overlap. The instructions also include instructions to generate a map with boundary lines adjusted for the lane conflicts.

In one embodiment, a method for comparing detected line pairs on a road and detecting lane conflicts for identifying boundary lines is disclosed. In one embodiment, the method includes comparing a similarity metric for different line pairs derived from detected keypoints. The method also includes detecting lane conflicts between vehicles identified with the line pairs using the similarity metric. The method also includes resolving the lane conflicts by comparing parameters of the line pairs that overlap. The method also includes generating a map with boundary lines adjusted for the lane conflicts.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element drawn to scale.

FIG. 1 illustrates one embodiment of a vehicle within which systems and methods disclosed herein may be implemented.

FIG. 2 illustrates one embodiment of an estimation system that is associated with comparing detected line pairs on a road and detecting lane conflicts for identifying boundary lines.

FIGS. 3A-3C illustrate examples of inferring associative relationships among vehicles using line pairs and identifying lane conflicts for automatically identifying boundary lines.

FIGS. 4A and 4B illustrate examples of graphing and quantifying across possible associative relationships between vehicles traveling on a road.

FIG. 5 illustrates an example of resolving lane conflicts by optimizing a spanning tree across possible associative relationships.

FIG. 6 illustrates one embodiment of a method that is associated with resolving detected lane conflicts by comparing parameters of line pairs that overlap.

### DETAILED DESCRIPTION

Systems, methods, and other embodiments associated with comparing detected lines and vehicle relationships for identifying and resolving lane conflicts and inferring boundary lines on a road are disclosed herein. In various implementations, vehicle systems detect boundary lines on a road using sensor data (e.g., camera data, images, etc.) for supporting vehicle tasks such as generating maps, updating maps, automated driving, etc. For example, a system associates lane boundaries using lines formed with detected keypoints along a trajectory. The systems detecting and generating boundary lines from keypoints detected by numerous vehicles can encounter erroneous results and conflicts, such as from acquiring sensor data during lane changes. For instance, a system mistakenly identifies a road boundary as a lane boundary when a detected left line is actually associated with an adjacent lane. In another example, a boundary line beyond a field-of-view (FoV) of vehicle sensors (e.g., a camera, an infrared sensor, etc.) goes undetected, such as a boundary line from an adjacent lane. Furthermore, inferring boundary lines can involve erroneously mistaking that a vehicle is collecting data associated with different lanes when the data is from the current lane. As such, the system assumes that the vehicle is traveling in both the current lane and an adjacent lane, thereby encountering a lane conflict. Thus, systems detecting boundary lines on a road encounter sensor errors and conflicting detections, thereby reducing reliability and confidence for vehicle tasks relying upon the boundary lines.

Therefore, in one embodiment, an estimation system detects lane conflicts for vehicles using a similarity metric for line pairs and resolves the lane conflicts through comparing parameters from an overlap. Here, a similarity metric may represent associative relationships between the vehicles. For example, the associative relationship is that the vehicles are co-occupying a lane having a particular line pair representing a boundary line (e.g., a road boundary, a lane boundary, etc.). Furthermore, a line for a line pair can be derived from image data. The line pair can also be formed using detected keypoints. A keypoint can be a salient point derived from sensor data (e.g., an image, video, etc.) that matches features within a scene (e.g., a driving environment). In one approach, the estimation system resolves a lane conflict that is detected by comparing parameters associated with overlapping data. For instance, a parameter is a line size between the line pairs, a number of detected keypoints for the line pairs, a FoV between sensors, and so on that overlap through having corresponding x-values, corresponding x and y values, etc. The estimation system can compare the parameter against a threshold for resolving a conflict about the vehicles mistakenly occupying a lane when traveling in different lanes. This avoids erroneously associating line pairs with a boundary line, such as within current and adjacent lanes, thereby improving system accuracy and performance.

Moreover, in various implementations, the estimation system graphs the line pairs across possible associative relationships and resolves lane conflicts through optimization. For example, a spanning tree maps vehicles traveling on a road as nodes and parameters representing line sizes that overlap as edges. The line sizes can form weights for the edges and detected directions (e.g., left, right, etc.) associated with the line pairs indicate relational position among the spanning tree. In one approach, the estimation system detects and resolves the lane conflict efficiently through comparing and removing lesser values of the weighted edges, thereby reducing complex computations. Accordingly, the estimation system accurately resolves lane conflicts for identifying boundary lines through comparing overlap parameters and graphing line pairs for efficient computations, thereby improving vehicle tasks relying upon accurate boundary lines.

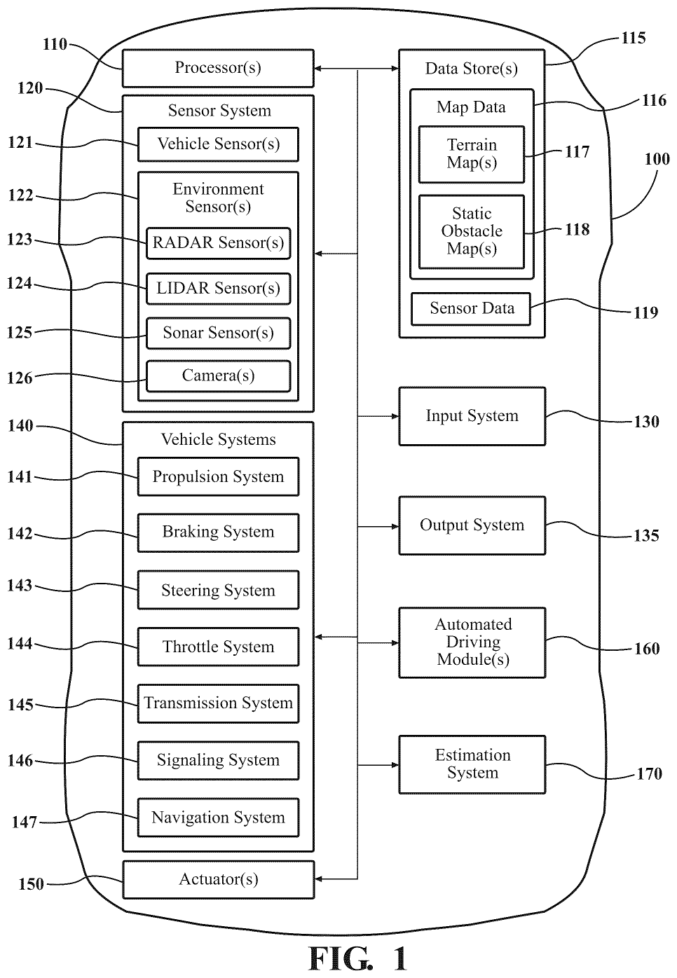

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, an estimation system 170 uses road-side units (RSU), consumer electronics (CE), mobile devices, robots, drones, and so on that benefit from the functionality discussed herein associated with comparing detected lines and vehicle relationships for identifying and resolving lane conflicts and inferring boundary lines on a road.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances. For example, as discussed, one or more components of the disclosed system can be implemented within a vehicle while further components of the system are implemented within a cloud-computing environment or other system that is remote from the vehicle 100.

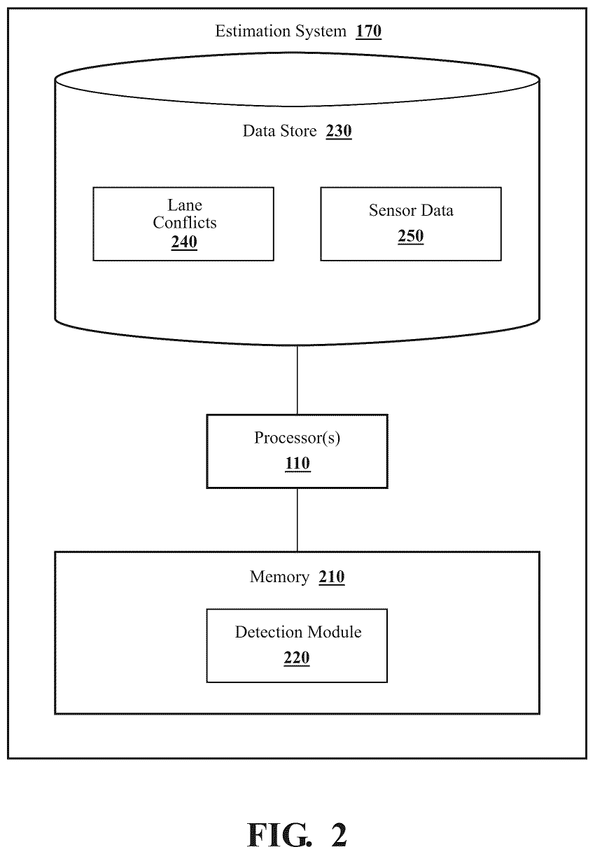

Some of the possible elements of the vehicle 100 are shown in FIG. 1 and will be described along with subsequent figures. However, a description of many of the elements in FIG. 1 will be provided after the discussion of FIGS. 2-6 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes an estimation system 170 that is implemented to perform methods and other functions as disclosed herein relating to comparing detected lines and vehicle relationships for identifying and resolving lane conflicts and inferring boundary lines on a road.

With reference to FIG. 2, one embodiment of the estimation system 170 of FIG. 1 is further illustrated. The estimation system 170 is shown as including a processor(s) 110 from the vehicle 100 of FIG. 1. Accordingly, the processor(s) 110 may be a part of the estimation system 170, the estimation system 170 may include a separate processor from the processor(s) 110 of the vehicle 100, or the estimation system 170 may access the processor(s) 110 through a data bus or another communication path. In one embodiment, the estimation system 170 includes a memory 210 that stores a detection module 220. The memory 210 is a random-access memory (RAM), a read-only memory (ROM), a hard-disk drive, a flash memory, or other suitable memory for storing the detection module 220. The detection module 220 is, for example, computer-readable instructions that when executed by the processor(s) 110 cause the processor(s) 110 to perform the various functions disclosed herein. Furthermore, the estimation system 170 as illustrated in FIG. 2 is generally an abstracted form of the estimation system 170 as may be implemented between the vehicle 100 and a cloud-computing environment.

In FIG. 2, the detection module 220 generally includes instructions that function to control the processor(s) 110 to receive data inputs from one or more sensors of the vehicle 100. The inputs are, in one embodiment, observations of one or more objects in an environment proximate to the vehicle 100 and/or other aspects about the surroundings. As provided for herein, the detection module 220, in one embodiment, acquires sensor data 250 that includes at least camera images. In further arrangements, the estimation system 170 and the detection module 220 acquire the sensor data 250 from further sensors such as radar sensors 123, LIDAR sensors 124, and other sensors as may be suitable for identifying vehicles and locations of the vehicles.

Accordingly, the estimation system 170 and the detection module 220, in one embodiment, control the respective sensors to provide the data inputs in the form of the sensor data 250. Additionally, while the estimation system 170 is discussed as controlling the various sensors to provide the sensor data 250, in one or more embodiments, the estimation system 170 can employ other techniques to acquire the sensor data 250 that are either active or passive. For example, the estimation system 170 passively sniffs the sensor data 250 from a stream of electronic information provided by the various sensors to further components within the vehicle 100. Moreover, the estimation system 170 can undertake various approaches to fuse data from multiple sensors when providing the sensor data 250 and/or from sensor data acquired over a wireless communication link. Thus, the sensor data 250, in one embodiment, represents a combination of perceptions acquired from multiple sensors.

In addition to locations of surrounding vehicles, the sensor data 250 may also include, for example, information about boundary lines, lane boundaries, road boundaries, lane markings, and so on. Moreover, the estimation system 170, in one embodiment, controls the sensors to acquire the sensor data 250 about an area that encompasses 360 degrees about the vehicle 100 in order to provide a comprehensive assessment of the surrounding environment. Of course, in alternative embodiments, the estimation system 170 may acquire the sensor data about a forward direction alone when, for example, the vehicle 100 is not equipped with further sensors to include additional regions about the vehicle and/or the additional regions are not scanned due to other reasons.

Moreover, in one embodiment, the estimation system 170 includes a data store 230. In one embodiment, the data store 230 is a database. The database is, in one embodiment, an electronic data structure stored in the memory 210 or another data store and that is configured with routines that can be executed by the processor(s) 110 for analyzing stored data, providing stored data, organizing stored data, and so on. Thus, in one embodiment, the data store 230 stores data used by the detection module 220 in executing various functions. In one embodiment, the data store 230 includes the sensor data 250 along with, for example, metadata that characterize various aspects of the sensor data 250. For example, the metadata can include location coordinates (e.g., longitude and latitude), relative map coordinates or tile identifiers, time/date stamps from when the separate sensor data 250 was generated, and so on. In one embodiment, the data store 230 further includes lane conflicts 240 representing occasions where the estimation system 170 perceives that a vehicle is concurrently occupying multiple lanes from vehicle relationships derived from detected line pairs. As further explained below, such a conflict can arise when mistakenly identifying a line from a line pair for a current lane with an adjacent lane.

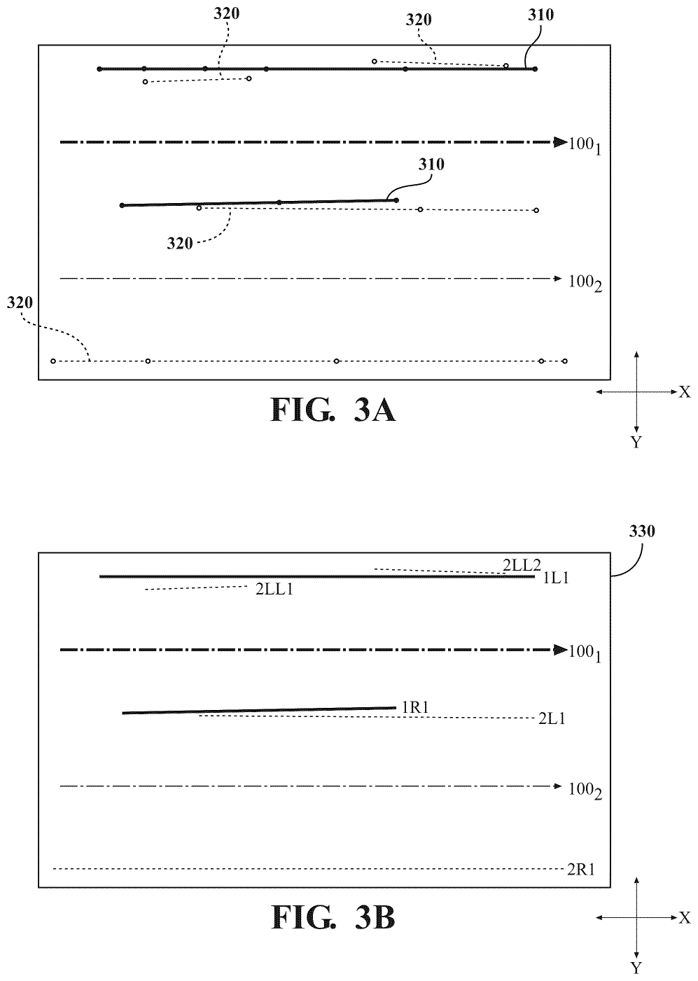

Now turning to FIGS. 3A-3C, examples of inferring associative relationships among vehicles using line pairs and identifying lane conflicts for automatically identifying boundary lines are illustrated. In various implementations, the estimation system 170 includes instructions that cause the processor 110 to compare a similarity metric for different line pairs derived from detected keypoints and the detection module 220 detects lane conflicts for vehicles identified with the line pairs using the similarity metric. Furthermore, the estimation system 170 can resolve the lane conflicts by comparing parameters of the line pairs that overlap. Here, an overlap can be lines detected from keypoints having values that partially, completely, minimally, etc., intersect. An overlap can also be lines detected by different vehicles running along a coordinate axis (e.g., x-axis) that do not have intersecting values. Upon resolving the lane conflicts about vehicle relationships, the estimation system 170 can generate a map with boundary lines with increased accuracy and reliability.

Regarding details about deriving line pairs from detected keypoints, FIG. 3A illustrates keypoints detected by different vehicles 100₁ and 100₂ on a road. In the examples given herein, lines forming the line pairs and boundary lines are identified online, offline, or any combination thereof. Although examples reference keypoints, a line pair can be formed directly using image data. Furthermore, the vehicle 100, a server, remote server, a cloud server, etc., can independently or partly form the lines and identify the boundary lines. Here, server processing can reduce computation loads for the vehicle 100 associated with detecting boundary lines and resolving lane conflicts, particularly during vehicle modes that are critical (e.g., automated driving). In another example, the vehicle 100₁ acquires and merges fleet data from the server that includes line detections about the road for predicting boundary lines and generating maps, accordingly.

In FIG. 3A, the keypoints 310 as illustrated can be generated by the vehicle 100₁, while keypoints 320 can be generated by 100₂. As previously explained, a keypoint can be a relevant point derived from the sensor data 250 (e.g., an image, video, etc.) that matches features within a scene (e.g., a driving environment). In one approach, a safety system (e.g., Toyota Safety Sense (TSS)) generates the sensor data 250 for the estimation system 170 to detect the keypoints 310. Additionally, a sporadic line (e.g., dotted, dashed, etc.) can be a trace representing a current path, trajectory, etc., for the vehicle 100₁ currently traveling along the road. For example, the trace is associated with a pose derived from images of the sensor data 250 representing object orientation and position. Similarly, the vehicle 100₂ follows another sporadic line (e.g., dotted, dashed, etc.) that is a trace representing a current path, trajectory, etc.

In one approach, the vehicle 100₂ detects lines by connecting the keypoints 320 and perceiving an adjacent lane from where the vehicle 100₁ is currently traveling. Here, the vehicle 100₂ detects lines through acquiring the sensor data 250 from a sensor having an expanded FoV. As such, the vehicle 100₂ has diverse and robust information about boundary lines while traveling along the road.

As illustrated in FIG. 3A, the vehicle 100₁ can form lines about the current lane while receiving information about other lanes directly from the vehicle 100₂, through a server, etc., and identify boundary lines accordingly. In various implementations, the vehicle 100₁ forms lines about multiple lanes on a road to compare with lines formed by the vehicle 100₂ on the current road. This information can be acquired by the vehicle 100₁ directly from the vehicle 100₂, remotely through a cloud network, a server, etc. Thus, the vehicle 100₁ can access diverse sources about lines detected with keypoints for identifying boundary lines that improve accuracy.

Regarding additional details about forming lines, the estimation system 170 connects detected keypoints derived from the sensor data 250 of the vehicle 100₁ and forms lines accordingly. Although examples reference keypoints, a line pair can be formed directly using image data. In one approach, forming a line involves ordering the keypoints and connecting consecutive keypoints relative to a trace (e.g., a vehicle trajectory) that establishes a line pair with improved smoothness. Here, a line pair can represent grouped lines formed by multiple vehicles that overlap along longitudinal paths. In one embodiment, an overlap are lines detected from keypoints having values that partially, completely, minimally, etc., intersect. An overlap can also be lines detected by different vehicles running along a coordinate axis (e.g., x-axis) that do not have intersecting values, such as when measuring a lateral gap. As such, a gap can be a lateral distance between line pairs. Furthermore, the estimation system 170 can predict alignment between the vehicle 100₁ and the vehicle 100₂ using a similarity between a line pair, such as an area between overlapping areas of a line pair for measuring a lane offset. For instance, differences between positional values of traces between the vehicle 100₁ and the vehicle 100₂ to a boundary line identified through associative relationships between the line pairs can indicate a lateral offset.

For added accuracy, in one approach, the estimation system 170 uses a machine learning (ML) algorithm, such as a convolutional neural network (CNN), to perform semantic segmentation over the sensor data 250 and identify lines. Of course, in further aspects, the estimation system 170 may employ different ML algorithms or implement different approaches for performing the associated functions, which can include deep convolutional encoder-decoder architectures, or another suitable approach that generates semantic labels for the separate object classes represented in the image. Whichever particular approach the estimation system 170 implements, an output can include semantic labels identifying objects represented in the sensor data 250. As such, comparing formed lines, line location, and size predicted with the ML algorithm through connecting the detected keypoints can increase accuracy.

Now turning to FIG. 3B, the detected keypoints 310 and 320 having labels is illustrated. Here, a label can identify a line estimated for a keypoint(s) with the following: a vehicle identification (ID); a right detection or a left detection indicator relative to a trace (e.g., a trajectory) including lines within an adjacent lane; and a detection instance (e.g., an integer, an alphanumeric value, etc.). For example, FIG. 3B includes the following labels upon road 330:
1L1—first immediate left line detected by the vehicle 100₁;
1R1—first immediate right line detected by the vehicle 100₁;
2L1—first immediate left line detected by the vehicle 100₂;
2R1—first immediate right line detected by the vehicle 100₂;
2LL1—first further left line detected by the vehicle 100₂ (e.g., adjacent lane); and
2LL2—second further left boundary detected by the vehicle 100₂ (e.g., adjacent lane).

FIG. 3C illustrates the estimation system 170 testing hypotheses about a vehicle relationship using a similarity metric among line pairs for detecting a lane conflict, resolving the lane conflict, and identifying boundary lines on a road 340. The similarity metric can include associative relationships between the vehicles and the line pairs such as vehicles co-occupying a lane, traveling in different lanes, etc., associated with a lane conflict. In one approach, the estimation system 170 compares parameters associated with overlapping data for resolving the lane conflict detected by the detection module 220. For example, a parameter is a line size between the line pairs, a number of detected keypoints for the line pairs within a limited range, a FoV between sensors from the vehicles, etc. As another example, the parameter is a line geometry that is encoded as a sequence of vertices.

Moreover, the vehicle 100₃ is co-occupying lane 350 with the vehicle 100₁ along the road 340. Here, the vehicle 100₃ may be unable to “see” the right boundary line of the lane 350 using data acquired from sensors (e.g., LiDAR, a camera, etc.). For example, the vehicle 100₃ is unable to see the right boundary line from acquiring noisy sensor data, mislabeling detected keypoints from reading errors of the sensor data 250, mislabeling the sensor data 250 during a lane change, etc. As such, the vehicle 100₃ identifies the line 3L1 with both 1L1 and 2LL2 suggesting that the vehicle 100₃ is occupying the lane 350 with the vehicle 100₁. Since the estimation system 170 can also pair 3R1 with 2R1 a hypothesis suggests that the vehicle 100₃ is occupying the lane 360 with the vehicle 100₂ and also occupying the lane 350, thereby facing a lane conflict involving a vehicle relationship.

In one approach, the estimation system 170 resolves the lane conflict by comparing overlapping lengths of the line pairs for various occupancy assumptions. For FIG. 3C, hypothesis 1 is that the vehicle 100₁ and the vehicle 100₂ are traveling upon the lane 350 together and involve 2.0 kilometers (km) of overlapping line pairs. However, hypothesis 2 is that the vehicle 100₂ and the vehicle 100₃ are traveling together in the lane 360 and involve an overlap of 0.3 km for the line pairs. Accordingly, the estimation system 170 compares the hypotheses and selects hypothesis 1 as likely the accurate associative relationship and line pair. The hypothesis 2 is disregarded as likely inaccurate. As further explained below, the estimation system 170 can also resolve lane conflicts and identify boundary lines through graphing across various associative relationships for line pairs.

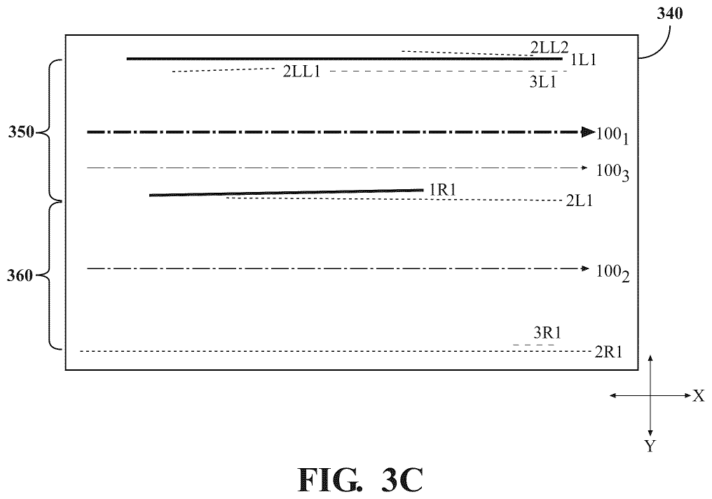

FIGS. 4A and 4B illustrate examples of graphing and quantifying across possible associative relationships between vehicles traveling on the road 340. Here, graph 410 has nodes indicating vehicles and edges that have parameter values utilized for comparing a line pair. A parameter value can be associated with one or more line pairs. For example, an edge represents a most probable relationship between vehicles. In another approach, the graph 410 includes multiple probabilities for an edge reflecting a possible relationship between vehicles. Directional arrows indicate left/right lane relations and co-occupancy with an ego relationship between vehicles in a lane. An ego vehicle can be a vehicle acquiring the sensor data 250 for perceiving features of the road 340 associated with resolving lane conflicts and predicting boundary lines.

Initially, the estimation system 170 predicts that the vehicle 100₁ and the vehicle 100₃ are co-occupying a lane by satisfying a threshold using certain parameters (e.g., a line size between the line pairs) and resolves lane conflicts through optimizing the graph 410. For example, the graph 410 tests that the vehicle 100₁ is a vehicle occupying a lane with the vehicle 100₃. The vehicle 100₁ and the vehicle 100₃ indicate a line pair 1 that can relate two detected lines having an overlapping line size of 2.0 as a parameter E(2.0). This hypothesis can indicate that the vehicle 100₁ and the vehicle 100₃ exhibit an ego relationship since the vehicles have 2.0 km of line detections. For instance, the line pair 1 includes 1L1 and 3L1. Another associative relationship is that the vehicle 100₂ is traveling right of the vehicle 100₁ in another lane. Here, the line pair 2 can be 1L1 and 2LL2 having an overlapping line size of 1.4 (e.g., 1.4 km) reflected with a parameter R(1.4). In other words, a line size can be a length of overlap involving associated lines from a line pair. In various implementations, the graph 410 tests the assumption that the vehicle 100₁ and 100₂ are traveling in different lanes through measuring the overlap between the line pair 1L1 and 2LL1, the line pair 1R1 and 2L1, etc. As such, the overlap can indicate a similarity between lines from a line pair quantifiable through lateral distance, an area between the lines, etc. The results of this assumption can be graphed and compared with other associative relationships.

Moreover, the graph 410 also includes a different assumption that the vehicle 100₂ is an ego vehicle occupying a lane with the vehicle 100₃. Here, the line pair 3 can include 2R1 and 3R1 having an overlapping line size of 0.3 (e.g., 0.3 km) as parameter E(0.3). As such, the graph 410 includes a lane conflict that the vehicle 100₃ is occupying a lane with both the vehicle 100₁ and the vehicle 100₂. Put differently, the lane conflict reflects an inconsistency suggesting that vehicles 100₁, 100₂, and 100₃ are occupying the same lane and also suggesting vehicles 100₁ and 100₂ are located in different lanes.

In FIG. 4B, the estimation system 170 optimizes the graph 410 for resolving the lane conflict where edges E(2.0) and R(1.4) meet a threshold while E(0.3) does not meet the threshold. For example, the threshold is that an overlap of line sizes is at least z. As explained below, another approach is maximizing the graph 410 through removing edges having diminished values. In FIG. 4B, the estimation system 170 resolves the lane conflict by eliminating E(0.3) through the optimization 420. Accordingly, the estimation system 170 predicts that the vehicle 100₁ and 100₃ are co-occupying the lane 350 while the vehicle 100₂ is outside the lane 350 and likely occupies the lane 360.

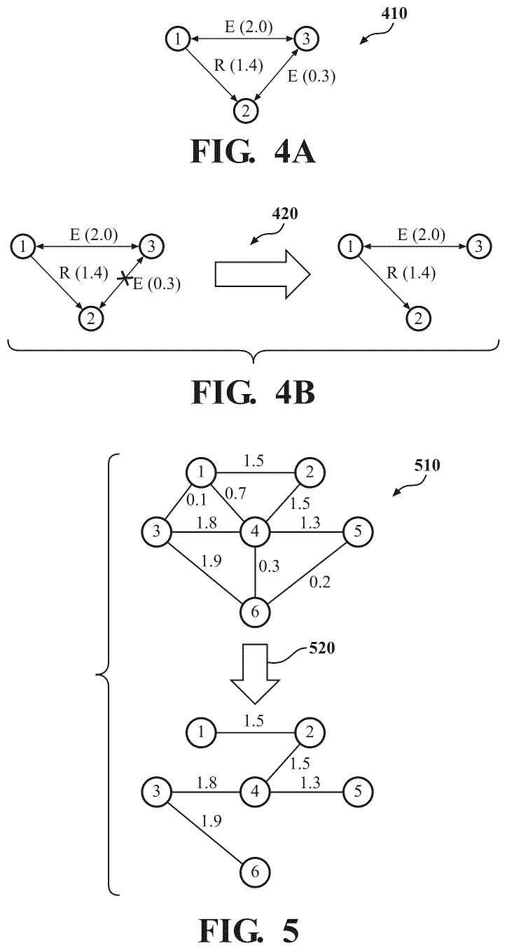

As further examples, FIG. 5 illustrates resolving a lane conflict by optimizing a spanning tree representation across associative relationships that are possible. Resolving the lane conflict can involve solving inconsistent relationships within a graph through removing edges so that the graph becomes a maximum spanning tree. The graph 510 relates vehicles through line pairs using a similarity metric in the spanning tree having weighted edges. For instance, the graph 510 indicates relative lateral positions between vehicles such as through a number of lanes between the vehicles. In various implementations, the estimation system 170 encounters numerous overlapping situations involving multiple vehicles that create complex lane conflicts. The estimation system 170 can reduce computational costs associated with resolving lane conflicts that are complex using the graph 510 and finding a spanning tree. The graph 510 has nodes representing vehicles and edges can be weights indicating parameter values (e.g., line size) for an overlapping line pair. The edges are also associated with directions such as left (L), right (R), and ego (E) for vehicles occupying the same lane. Here, the graph 510 includes six vehicles having associative relationships and parameter weights for line pairs: [0.1, 1.5, 0.7, 1.5, 1.8, 1.9, 1.3, 0.3, and 0.2]. For example, vehicle 1 has an overlapping line pair with vehicle 2 as E(1.5) with an assumed associative relationship that the vehicles are traveling within the same lane. Vehicle 1 also has an overlapping line pair with vehicle 4 as R(0.7) with an assumed associative relationship that the vehicles are traveling in different lanes. The vehicle 4 may also be occupying a lane right of the vehicle 1. Furthermore, the vehicle 4 also has an overlapping line pair with vehicle 2 as L(1.5) with an assumed associative relationship that the vehicles are traveling in different lanes. The vehicle 2 is also likely occupying a lane left of the vehicle 4.

Maximizing the graph 510 using a spanning tree algorithm may involve finding a spanning tree having a weighted edge greater than or equal to weighted edges across possible spanning trees. A path in the maximum spanning tree can be a widest path in the graph 510 between endpoints (e.g., 2). In one approach, the algorithm maximizes weight edges existing within the graph 510 through removal using a greedy-approach that eliminates lane conflicts among possible paths. For instance, the optimization 520 removes weaker edges [0.1, 0.7, 0.3, and 0.2] that minimizes weighted edges and improves confidence for associative relationships by partitioning the graph and removing conflicts and contradictions by partition. The optimization also avoids incurring unnecessary cycles that increase computational costs. For example, a conflict is a vehicle concurrently occupying multiple lanes, a contradiction is more than w vehicles (e.g., three) occupying the same lane, etc. As such, the graph 510 indicates that associative relationships between vehicles 1-6 and line pairs having values [1.5, 1.5, 1.8, 1.3, and 1.9] exhibiting increased accuracy for selecting boundary lines. Accordingly, the estimation system 170 can generate and update map data with boundary lines associated with the line pairs [1.5, 1.5, 1.8, 1.3, and 1.9].

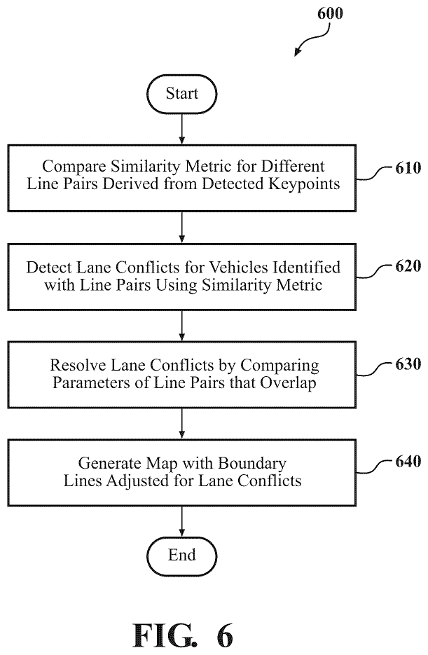

Regarding FIG. 6, one embodiment of a method 600 that is associated with resolving detected lane conflicts by comparing parameters of line pairs that overlap is illustrated. Method 600 will be discussed from the perspective of the estimation system 170 of FIGS. 1 and 2. While the method 600 is discussed in combination with the estimation system 170, it should be appreciated that the method 600 is not limited to being implemented within the estimation system 170 but is instead one example of a system that may implement the method 600. In one approach, the method 600 predicts relative vehicle positions and possible associations between vehicles using detected keypoints and lines while resolving conflicting associations for identifying boundary lines that increase accuracy.

At 610, the estimation system 170 compares a similarity metric for different line pairs derived from detected keypoints. In various implementations, the estimation system 170 identifies vehicle pairs and iterates over possible relationships (e.g., ego, left, right, etc.). For a possible relationship, the estimation system 170 identifies boundary line pairs that correspond and quantifies similarities for the line pairs. This can involve deriving an overall score and probability from the similarity scores reflecting a probability of a hypothesized vehicle relationship (e.g., ego, left, right, etc.). The estimation system 170 can graph the scores, probabilities, etc., for resolving a lane conflict.

The similarity metric may represent associative relationships between vehicles supplying the sensor data 250. For example, the associative relationship is that the vehicles are co-occupying a lane having a particular line pair as a boundary line (e.g., a road boundary, a lane boundary, etc.). Here, a keypoint can be a relevant point derived from the sensor data 250 (e.g., an image, video, etc.) that matches features within a scene (e.g., a driving environment). Although examples reference keypoints, a line pair can be formed directly using image data. In one approach, the vehicle 100 and the detection module 220 detect lines by connecting the keypoints and perceiving an adjacent lane where another vehicle is currently traveling. The vehicle 100 detects lines through acquiring the sensor data 250 from a sensor having an expanded FoV. The estimation system 170 can form lines by connecting detected keypoints derived from the sensor data 250 for one or more lanes. A line pair represents grouped lines formed by multiple vehicles on a road that overlap along longitudinal paths.

In various implementations, an overlap are lines with keypoints having values that partially, completely, minimally, etc., intersect among an approximated coordinate graph. As previously explained, an overlap can also be lines detected by different vehicles running along a coordinate axis (e.g., x-axis) that do not have intersecting values, such as when measuring a lateral gap. As such, a gap can be a lateral distance between line pairs. Furthermore, the estimation system 170 can predict alignment between vehicles using a similarity between a line pair. This includes an area between overlapping areas of a line pair for measuring a lane offset through comparing position and pose of the vehicles.

At 620, the detection module 220 detects the lane conflicts 240 for vehicles identified with the line pairs using the similarity metric. A lane conflict can be line pairs for traces (e.g., trajectories) suggesting that a vehicle is concurrently occupying multiple lanes, numerous vehicles occupying the same lane, etc. As previously explained, various scenarios can create the lane conflicts 240 associated with vehicle relationships and lane occupancy. For example, the vehicle 100 is unable to reliably locate a boundary line when the sensor data 250 is noisy. In another example, detected keypoints are mislabeled from reading errors of the sensor data 250 or mislabeled during a lane change. This can result in vehicles having multiple lines that overlap above a minimum threshold for different boundary lines along multiple lanes. As such, the vehicle 100 erroneously pairs lines with multiple detections suggesting that the vehicle 100 and other vehicles are co-occupying a lane.

At 630, the estimation system 170 resolves the lane conflicts 240 by comparing parameters of the line pairs that overlap. Here, a parameter can indicate confidence of detected keypoints across possible occupancy scenarios and overlapping line pairs. The parameter can be a line size between the line pairs, a number of detected keypoints for the line pairs among a limited range, a FoV between sensors from the vehicles, etc., that overlap. For example, hypothesis 1 is that the vehicle 100 and another vehicle are traveling on a lane together and involve a₁ distance of overlapping line pairs. However, hypothesis 2 is that the vehicle 100 and a different vehicle are traveling together in another lane (e.g., a left adjacent lane, a right adjacent lane, etc.) and involve an overlap of a₁-a₂ for the line pairs. This indicates a potential lane conflict with the vehicle 100 hypothetically occupying two lanes. Accordingly, the estimation system 170 compares the hypotheses and selects hypothesis 1 as likely the accurate associative relationship and line pair when a₁ is greater than a₁-a₂. The hypothesis 2 can be disregarded as likely a lane conflict.

Moreover, in various implementations, the estimation system 170 graphs and quantifies across associative relationships that are possible between vehicles traveling on a road. A graph can relate line pairs using a similarity metric in a tree having weighted edges. The estimation system 170 can reduce computational costs associated with resolving the lane conflicts 240 that are complex using the graph through optimizing the edges. Here, the graph can include nodes representing vehicles and edges with weights indicating parameter values (e.g., line size) for overlapping line pairs. In one approach, the edges have directions such as left (L), right (R), and ego (E) for vehicles occupying the same lane and related values (e.g., 0.1, 2, 1.7, 0.6). Through removing weaker edges (e.g., 0.1 and 0.6), the estimation system 170 can optimize the graph, resolve the lane conflicts 240, and identify boundary lines for the road with increased accuracy.

Additionally, maximizing the graph can involve the estimation system 170 executing a spanning tree algorithm. This task may involve finding a spanning tree having a weighted edge greater than or equal to weighted edges across spanning tree combinations that are possible. As previously explained, a path in the maximum spanning tree can be a widest path in the graph between endpoints among possible paths. The algorithm maximizes a weight of a minimum-weighted edge for eliminating lane conflicts. For instance, a graph includes associative relationships and parameter weights for line pairs: [0.1, 1.5, 0.7, 1.5, 1.8, 1.9, 1.3, 0.3, and 0.2]. A maximization task involves removing weaker edges [0.1, 0.7, 0.3, and 0.2] that minimizes weighted edges existing on a graph. In this way, the maximization task removes lane conflicts without incurring unnecessary cycles that increase computational costs.

At 640, the estimation system 170 generates a map with boundary lines adjusted for the lane conflicts 240. Here, adjusting for the lane conflicts 240 can include selecting boundary lines from line pairs remaining upon removing weaker edges from a graph. Using the previous example, the estimation system 170 can generate and update map data with boundary lines associated with the line pairs {1.5, 1.5, 1.8, 1.9, and 1.3}. Regarding updating an existing map, the update tasks can correct an existing map that has gone stale, such as due to construction, land development, etc. In one approach, automated driving module 160 of the vehicle 100 updates tasks (e.g., lane keeping, lane tracking, etc.) using boundary lines selected by the estimation system 170, thereby improving safety. Accordingly, the estimation system 170 revolves lane conflicts from line pairs involving associative relationships for automatically and reliably identifying boundary lines while reducing computational complexity (e.g., maximizing a spanning tree), thereby improving vehicle tasks relying upon accurate lane information and maps.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate to the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the estimation system 170, and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110, the estimation system 170, and/or the automated driving module(s) 160 may control some or all of the vehicle systems 140 and, thus, may be partially or fully autonomous as defined by the society of automotive engineers (SAE) levels 0 to 5.

The processor(s) 110, the estimation system 170, and/or the automated driving module(s) 160 can be operatively connected to communicate with the various vehicle systems 140 and/or individual components thereof. For example, the processor(s) 110, the estimation system 170, and/or the automated driving module(s) 160 can be in communication to send and/or receive information from the various vehicle systems 140 to control the movement of the vehicle 100. The processor(s) 110, the estimation system 170, and/or the automated driving module(s) 160 may control some or all of the vehicle systems 140.

The processor(s) 110, the estimation system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the estimation system 170, and/or the automated driving module(s) 160 can control the direction and/or speed of the vehicle 100. The processor(s) 110, the estimation system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the estimation system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An estimation system comprising:
a memory storing instructions that, when executed by a processor, cause the processor to:
compare a similarity metric for different line pairs derived from detected keypoints;
detect lane conflicts between vehicles identified with the line pairs using the similarity metric;
resolve the lane conflicts by comparing parameters of the line pairs that overlap; and
generate a map with boundary lines adjusted for the lane conflicts.

2. The estimation system of claim 1, wherein the instructions to resolve the lane conflicts further include instructions to:
compare the parameters using one of a line size between the line pairs, a lateral gap between the line pairs, a number of the keypoints for the line pairs, and a field-of-view between sensors from the vehicles; and
upon satisfaction of a threshold using the parameters, predict that a first vehicle and a second vehicle of the vehicles are co-occupying a lane.

3. The estimation system of claim 2 further including instructions to:
upon the threshold being unmet using the parameters, predict that the first vehicle is occupying the lane and a third vehicle from the vehicles is outside the lane.

4. The estimation system of claim 2 further including instructions to:
graph the line pairs using the similarity metric in a spanning tree having weighted edges associated with the parameters, the similarity metric includes associative relationships between the vehicles; and
eliminate the lane conflicts by optimizing the spanning tree using a minimum value of the weighted edges.

5. The estimation system of claim 1, wherein the instructions to detect the lane conflicts further include instructions to:
identify a line from one of the line pairs for a current lane with an adjacent lane.

6. The estimation system of claim 1 further including instructions to:
order the keypoints along a trajectory as a trace for one of the vehicles; and
associate the keypoints that are consecutive relative to the trace and one of the line pairs.

7. The estimation system of claim 1, wherein the similarity metric includes associative relationships between the vehicles and the line pairs on a road.

8. The estimation system of claim 7, wherein the associative relationships include one of the vehicles co-occupying a lane and traveling in different lanes associated with the lane conflicts.

9. The estimation system of claim 1, wherein the line pairs include labels with instance identifiers and the line pairs indicate estimated structure for one of a current lane and an adjacent lane.

10. A non-transitory computer-readable medium comprising:
instructions that when executed by a processor cause the processor to:
compare a similarity metric for different line pairs derived from detected keypoints;
detect lane conflicts between vehicles identified with the line pairs using the similarity metric;
resolve the lane conflicts by comparing parameters of the line pairs that overlap; and
generate a map with boundary lines adjusted for the lane conflicts.

11. The non-transitory computer-readable medium of claim 10, wherein the instructions to resolve the lane conflicts further include instructions to:
compare the parameters using one of a line size between the line pairs, a lateral gap between the line pairs, a number of the keypoints for the line pairs, and a field-of-view between sensors from the vehicles; and
upon satisfaction of a threshold using the parameters, predict that a first vehicle and a second vehicle of the vehicles are co-occupying a lane.

12. A method comprising:
comparing a similarity metric for different line pairs derived from detected keypoints;
detecting lane conflicts between vehicles identified with the line pairs using the similarity metric;
resolving the lane conflicts by comparing parameters of the line pairs that overlap; and
generating a map with boundary lines adjusted for the lane conflicts.

13. The method of claim 12, wherein resolving the lane conflicts further includes:
comparing the parameters using one of a line size between the line pairs, a lateral gap between the line pairs, a number of the keypoints for the line pairs, and a field-of-view between sensors from the vehicles; and
upon satisfying a threshold using the parameters, predicting that a first vehicle and a second vehicle of the vehicles are co-occupying a lane.

14. The method of claim 13 further comprising:
upon the threshold being unmet using the parameters, predicting that the first vehicle is occupying the lane and a third vehicle from the vehicles is outside the lane.

15. The method of claim 13 further comprising:
graphing the line pairs using the similarity metric in a spanning tree having weighted edges associated with the parameters, the similarity metric includes associative relationships between the vehicles; and
eliminating the lane conflicts by optimizing the spanning tree using a minimum value of the weighted edges.

16. The method of claim 12, wherein detecting the lane conflicts further includes:
identifying a line from one of the line pairs for a current lane with an adjacent lane.

17. The method of claim 12 further comprising:
ordering the keypoints along a trajectory as a trace for one of the vehicles; and
associating the keypoints that are consecutive relative to the trace and one of the line pairs.

18. The method of claim 12, wherein the similarity metric includes associative relationships between the vehicles and the line pairs on a road.

19. The method of claim 18, wherein the associative relationships include one of the vehicles co-occupying a lane and traveling in different lanes associated with the lane conflicts.

20. The method of claim 12, wherein the line pairs include labels with instance identifiers and the line pairs indicate estimated structure for one of a current lane and an adjacent lane.
